(19) United States
(12) Patent Application Publication
(10) Pub. No.: US 2016/0207472 A1
(43) Pub. Date: Jul. 21, 2016

(54) HOLDER ASSEMBLY

(71) Applicant: Caterpillar Inc., Peoria, IL (US)

(72) Inventors: Michael C. Marstall, Normal, IL (US); Benjamin C. Parrish, Decatur, IL (US); Joseph P. Miksan, Decatur, IL (US)

(73) Assignee: Caterpillar Inc., Peoria, IL (US)

(21) Appl. No.: 14/600,047

(22) Filed: Jan. 20, 2015

(51) Int. Cl. B60R 11/00; F15B 1/04; B60R 16/08

(52) U.S. Cl. CPC B60R 11/00; B60R 16/08; F15B 1/04; B60R 2011/0064

(57) ABSTRACT

A bracket assembly for an accumulator is provided. The bracket assembly includes a holding element. The holding element includes a body having a front surface and two side surfaces. The two side surfaces extend from the two ends of the front surface. The holding element also includes a corner portion disposed at each of the two ends of the front surface. The corner portion is formed by an angular relationship between the front surface and each of the two side surfaces at the respective end of the front surface. The bracket assembly also includes mold member extending from the inner side of the holding element. A thickness of the mold member at the corner portion is greater than a thickness of the mold member at the front surface of the holding element.

### TECHNICAL FIELD

The present disclosure relates to a holder assembly, and more particularly to a holder assembly for mounting of an accumulator.

### BACKGROUND

Machines such as those used in the mining industry include a hydraulic system associated with steering and/or brake systems of the machine. The hydraulic system includes accumulators associated therewith. The accumulators are configured to store pressurized fluid therein, which may be used by the hydraulic system during an operation of the machine. The accumulators are generally coupled to a frame of the machine using a holder system. The accumulators associated with the machines operating in the mining environment are generally large and heavy. It is desirable that the holder system is robust enough to survive the load of the accumulators. If not, the holder system may fail during an operation of the machine, thereby leading to an accumulator detachment and/or hydraulic system issues.

U.S. Pat. No. 8,418,727 describes an accumulator for a hydraulic system including a polymer liner defining a cavity. A metal bellows assembly is housed in the cavity and separates the cavity into a first chamber and a second chamber, with the first and second chambers isolated from one another by the bellows assembly. A composite shell substantially encases the liner. The liner and shell are configured so that the first chamber receives hydraulic fluid from and delivers hydraulic fluid through an opening in the liner and the shell as the bellows assembly expands and compresses due to pressurized gas in the second chamber balancing fluid pressure changes in the first chamber.

### SUMMARY OF THE DISCLOSURE

In one aspect of the present disclosure, a bracket assembly for an accumulator is provided. The bracket assembly includes a holding element. The holding element includes a body having a front surface and two side surfaces. The two side surfaces extend from two ends of the front surface. Further, an inner side of the holding element is configured to face the accumulator. The holding element also includes a corner portion disposed at each of the two ends of the front surface. The corner portion is formed by an angular relationship between the front surface and each of the two side surfaces at the respective end of the front surface. The bracket assembly also includes a mold member extending from the inner side of the holding element. A thickness of the mold member at the corner portion is greater than a thickness of the mold member at the front surface of the holding element, such that the mold member at the corner portion is configured to be in a contacting relationship with the accumulator.

In another aspect of the present disclosure, a holder assembly for an accumulator is provided. The holder assembly includes a housing having a hollow configuration. The housing includes one or more cut portions formed thereon, such that the one or more cut portions are provided laterally spaced apart from each other. Further, each of the one or more cut portions has a curved profile configured to receive the accumulator. The holder assembly also includes a holding element coupled to the housing. The holding element includes a front surface and two side surfaces. The two side surfaces extend from two ends of the front surface, wherein an inner side of the holding element is configured to face the accumulator. The holding element also includes a corner portion disposed at each of the two ends of the front surface. The corner portion is formed by an angular relationship between the front surface and each of the two side surfaces at the respective end of the front surface. The holder assembly also includes a mold member extending from the inner side of the holding element. A thickness of the mold member at the corner portion is greater than a thickness of the mold member at the front surface of the holding element, such that the mold member at the corner portion is configured to be in a contacting relationship with the accumulator.

In yet another aspect of the present disclosure, a system is provided. The system includes a plurality of accumulators. The system also includes a holder assembly for each of the plurality of accumulators. The holder assembly includes a housing having a hollow configuration. The housing includes one or more cut portions formed thereon. The one or more cut portions are provided laterally spaced apart from each other, wherein each of the one or more cut portions has a curved profile to receive each of the plurality of accumulators therein. The holder assembly also includes a holding element coupled to the housing. The holding element includes a body having a front surface and two side surfaces. The two side surfaces extend from two ends of the front surface, wherein an inner side of the holding element faces each of the plurality of accumulators. The holding element also includes a corner portion disposed at each of the two ends of the front surface. The corner portion is formed by an angular relationship between the front surface and each of the two side surfaces at the respective end of the front surface. The holder assembly also includes a mold member extending from the inner side of the holding element. A thickness of the mold member at the corner portion is greater than a thickness of the mold member at the front surface of the holding element, such that the mold member at the corner portion is in a contacting relationship with each of the plurality of accumulators.

Other features and aspects of this disclosure will be apparent from the following description and the accompanying drawings.

### BRIEF DESCRIPTION OF THE DRAWINGS

FIG. 1 is a side view of an exemplary mining truck, according to one embodiment of the present disclosure;

FIG. 2 is a perspective view of a holder assembly for mounting of a plurality of accumulators, according to one embodiment of the present disclosure;

FIG. 3 is a perspective view of a housing of the holder assembly of FIG. 2, according to one embodiment of the present disclosure;

FIG. 4 is an exploded view of a bracket assembly, according to one embodiment of the present disclosure,

FIG. 5 is a top view of the bracket assembly of FIG. 4; and

FIG. 6 is an assembled view of the housing and the bracket assembly, according to one embodiment of the present disclosure.

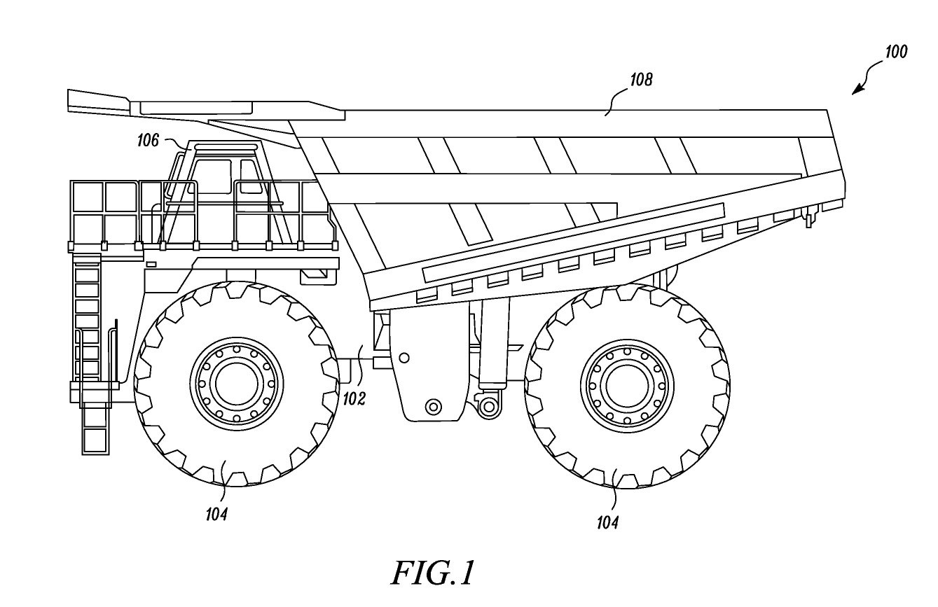

### DETAILED DESCRIPTION

Wherever possible, the same reference numbers will be used throughout the drawings to refer to the same or the like parts. An exemplary embodiment of a machine 100, according to the present disclosure is shown in FIG. 1. The machine 100 may be a mining truck, as shown, or may include any off-highway or on-highway vehicle using a fuel-powered engine, as described herein. The machine 100 generally includes a frame 102 for supporting, among other systems and components. It should be understood that the machine 100 may embody any wheeled or tracked machine associated with mining, agriculture, forestry, construction, and other industrial applications.

The machine 100 may include an engine (not shown) associated therewith. The machine 100 also includes a plurality of ground-engaging elements 104, in this case being wheels. As should be appreciated by one of ordinary skill in the art, the engine may provide propulsion power to the ground-engaging elements 104 and may power a variety of other machine systems, including various mechanical, electrical, and hydraulic systems and/or components. Further, the machine 100 may also include an operator control station 106, including a variety of operator controls and displays useful for operating the machine 100 and/or a dump body 108 which may be pivotal relative to the frame 102

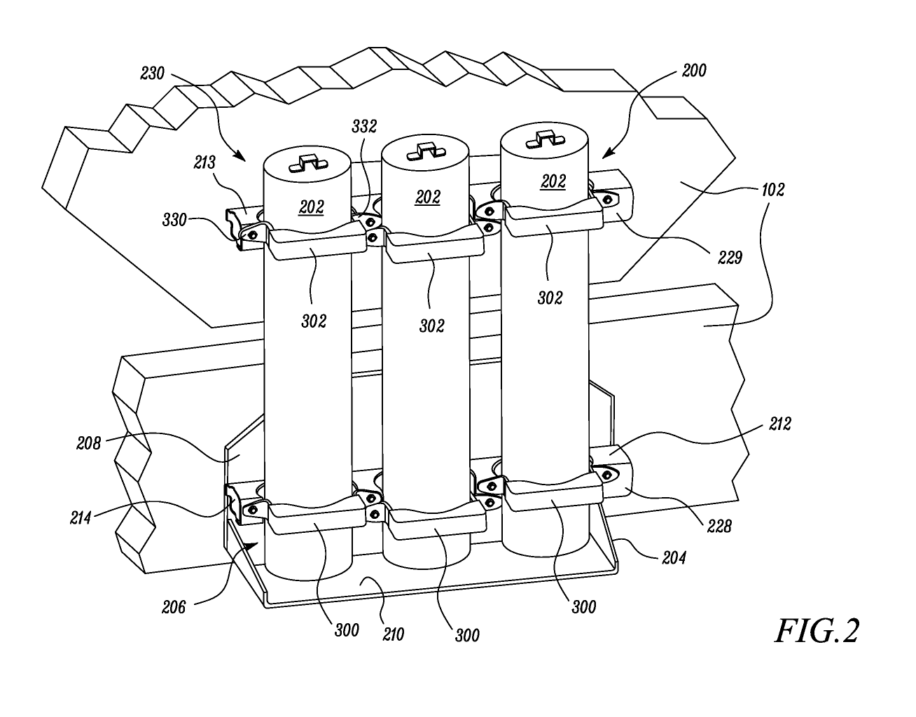

The machine 100 includes a braking system (not shown). An actuation of the braking system may slow down or halt the machine 100, as per an operator's command The braking system may be operated hydraulically, pneumatically, electrically, or mechanically. Further, the machine 100 includes a steering system (not shown). The steering system is configured to change a course of the machine 100, based on inputs from the operator. The steering system associated with the machine 100 may be operated hydraulically, pneumatically, electrically, or mechanically. In a situation wherein the steering and/or braking systems are hydraulically operated, the steering and/or braking systems may include a plurality of accumulators 202 associated therewith. Three such exemplary accumulators 202 are as shown in FIG. 2. The accumulators 202 may embody any type of a known energy storage device. For example, the accumulators 202 may include a pressure storage reservoir in which a hydraulic fluid may be stored under pressure. It should be noted that a type of the accumulator 202 disclosed herein is exemplary, and may include any known type of accumulators based on system requirements.

The present disclosure is directed towards a holder assembly 200. The holder assembly 200 is used for coupling the accumulators 202 to the frame 102 of the machine 100. The holder assembly 200 includes a fixture plate 204. The fixture plate 204 is provided near a bottom portion 206 of the accumulator 202. The fixture plate 204 is configured to be coupled to the frame 102 of the machine 100. More particularly, a first plate 208 of the fixture plate 204 is attached to the frame 102 of the machine 100. Further, each of the accumulators 202 is configured to rest on a second plate 210 of the fixture plate 204.

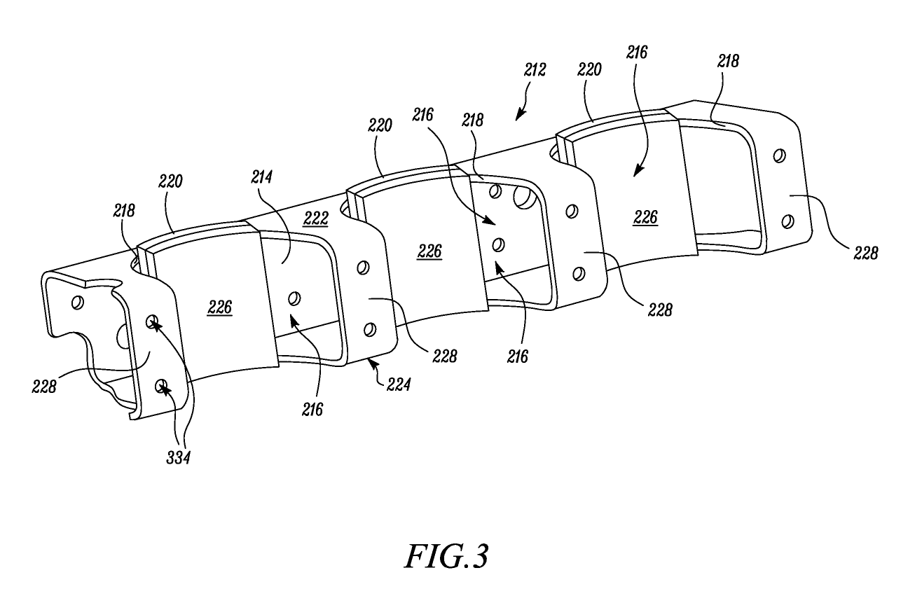

Referring to FIGS. 2 and 3, the holder assembly 200 includes a housing 212. The housing 212 is a unitary unit and has a hollow configuration. In one example, the housing 212 may be embodied as a tube. The housing 212 may be made of a metal, such as steel. In the illustrated embodiment, the housing 212 has an approximately square shaped cross-section. Alternatively, the housing 212 may have a rectangular, elliptical, circular, or other cross-section. The housing 212 includes a rear surface 214. The rear surface 214 of the housing 212 is configured to couple the housing 212 with the first plate 208 of the fixture plate 204. The housing 212 may be coupled to the fixture plate 204 using any known mechanical fastening means, such as, bolting, welding, soldering, riveting, and the like.

As shown in the accompanying figures, the housing 212 includes at least one cut portion 216. In one example, the cut portion 216 of the housing 212 may be formed using a laser cutting operation. Alternatively, the cut portion 216 may be formed using any conventional metal forming techniques known to a person of ordinary skill in the art. Further, a profile of the cut portion 216 is decided based on a shape of the accumulator 202. In the illustrated embodiment, the cut portion 216 of the housing 212 has a curved profile 218. The curved profile 218 of the cut portion 216 is configured to receive the accumulator 202 therein. Further, the number of the cut portions 216 in the housing 212 may depend on the number of accumulators 202 held by the holder assembly 200. The housing 212 of the illustrated embodiment includes three cut portions 216 provided along a length of the housing 212. The cut portions 216 on the housing 212 are provided laterally spaced apart from each other along a length of the housing 212.

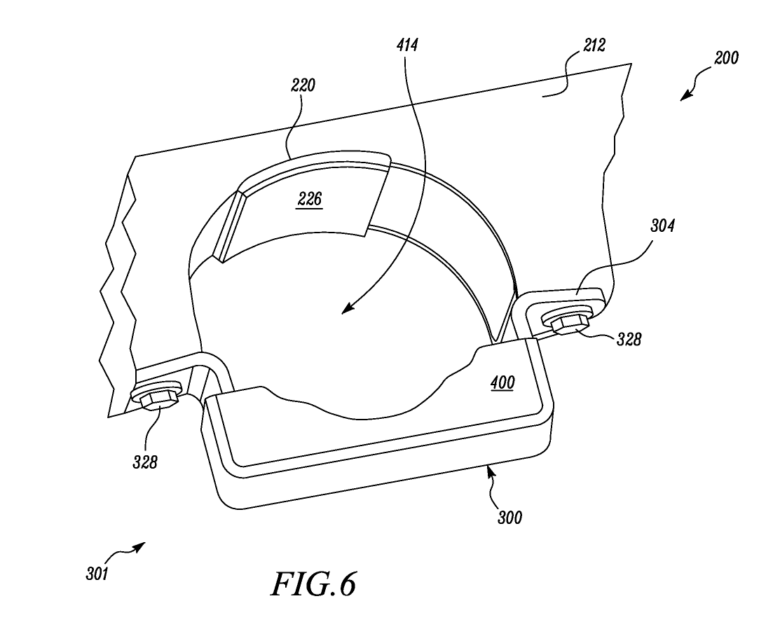

Referring to FIGS. 3 and 6, each cut portion 216 of the housing 212 is provided with an attachment plate 220. The attachment plate 220 is provided between a top surface 222 and a bottom surface 224 of the housing 212. More particularly, a top portion and a bottom portion of the attachment plate 220 are coupled to the top and bottom surfaces 222, 224 of the housing 212 respectively. The attachment plate 220 may be coupled to the housing 212 using any joining process known in the art, for example, welding, soldering, riveting, bolting, and the like. Further, each attachment plate 220 of the housing 212 is provided with a pad 226. The pad 226 is configured to contact the accumulator 202. The pad 226 may be made of an elastic material. In one example, the pad 226 may be made of rubber. Shape and dimensions of the pad 226 may be substantially similar to the shape and dimensions of the attachment plate 220. In one example, the pad 226 may be coupled to the attachment plate 220 using an adhesive. As shown in FIG. 3, the housing 212 of the holder assembly 200 includes attachment surfaces 228. Some of the attachment surfaces 228 of the housing 212 are provided between adjacent cut portions 216 of the housing 212. The attachment surfaces 228 are configured to be coupled to a holding element.

Referring to FIGS. 2, 4 and 5, the holder assembly 200 includes a bracket assembly 301, according to one embodiment of the present disclosure. The bracket assembly 301 includes a plurality of holding elements 300, 302. In the illustrated embodiment, two holding elements 300, 302 are associated with each accumulator 202 in order to hold the accumulator 202. More particularly, each accumulator 202 is provided with a first holding element 300 and a second holding element 302 (see FIG. 2). The first holding elements 300 are provided near the bottom portion 206 of the accumulator 202. The first holding elements 300 are configured to be coupled to the attachment surfaces 228 of the housing 212. Further, the second holding elements 302 are provided near a top portion 230 of the accumulators 202. The top portion 230 of the accumulators 202 also includes the housing 213. The housing 213 is coupled to the frame 102 of the machine 100 using suitable mechanical fastening means. Design and dimensions of the housing 213 is similar to that of the housing 212. The second holding elements 302 are coupled to the attachment surfaces 229 of the housing 213 using mechanical fasteners. It should be noted that the first and second holding elements 300, 302 may have similar design and structural features.

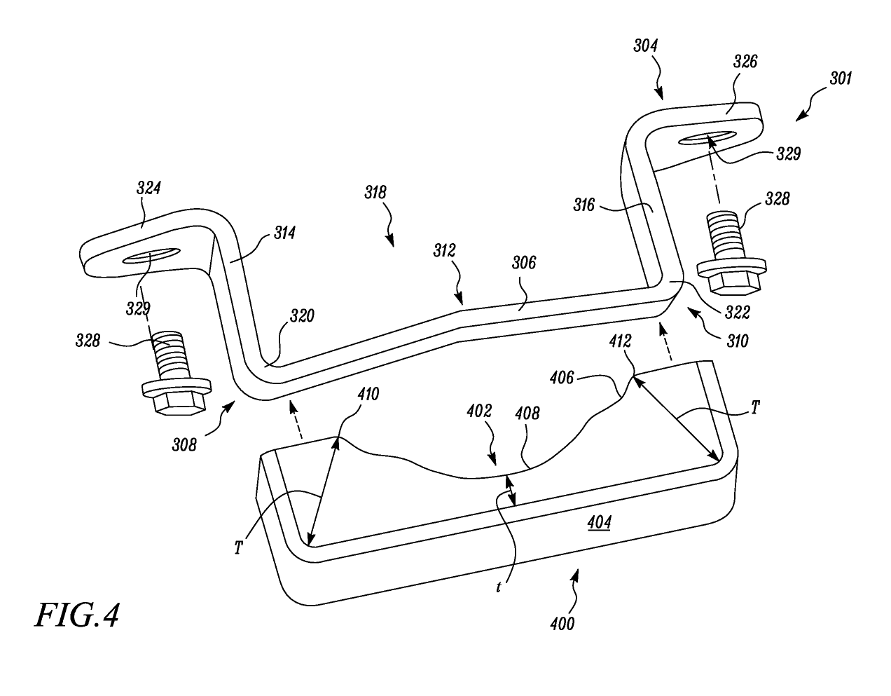

The present disclosure will be explained in reference to the first holding element 300. The first holding element 300 is hereinafter interchangeably referred to as the holding element 300. Referring to FIGS. 4 and 5 and 6, the holding element 300 includes a body 304. The body 304 has a front surface 306. The front surface 306 includes a first end 308 and a second end 310. The front surface 306 of the holding element 300 has a bent shape 312 at a central portion thereof. Further, an inner side 318 of the holding element 300 is configured to face the accumulator 202.

The body 304 also includes a pair of side surfaces, namely a first side surface 314 and a second side surface 316. The first and second side surfaces 314, 316 of the body 304 extend from the first and second ends 308, 310 of the front surface 306 respectively. The holding element 300 includes a corner portion 320, 322 disposed at each of the first and second ends 308, 310 of the front surface 306. The corner portions 320, 322 are formed by an angular relationship between the front surface 306 and each of the first and second side surfaces 314, 316 at the respective end 308, 310 of the front surface 306. In one example, the angular relationship between the front surface 306 and each of the first and second side surfaces 314, 316 at the respective end 308, 310 of the front surface 306 may be approximately between 65 to 100 degrees. In one embodiment, the angle between the front surface 306 and each of the respective first and second surfaces 314, 316 may be approximately between 65 to 85 degrees or approximately between 85 to 100 degrees. For example, the front surface 306 may form an angle of approximately 90 degrees with each of the first and second side surfaces 314, 316 of the holding element 300 respectively.

The holding element 300 includes a pair of mounting legs 324, 326 extending from each of the first and second side surfaces 314, 316 of the holding element 300. The pair of mounting legs 324, 326 is configured to couple the holding element 300 to the attachment surfaces 228 of the housing 212. Referring to FIGS. 2, 4, 5, and 6, the holding element 300 may be coupled to the housing 212 using mechanical fasteners 328. The mounting legs 324, 326 may include apertures 329. The attachment surfaces 228 of the housing 212 also include corresponding apertures 334, such that the apertures 329, 334 are aligned in order to receive the mechanical fasteners 328. The mechanical fasteners 328 may include any one of a bolt, screw, rivet, pin, and the like. Alternatively, any known joining process, such as, welding, soldering, or brazing may be used to couple the holding elements 300 to the attachment surfaces 228. In case of the second holding element 302, the pair of mounting legs 330, 332 (see FIG. 2) is configured to couple the second holding element 302 to the attachment surfaces 229 of the housing 213.

It should be noted that the body 304 of the holding element 300 may have a unitary piece design. Any known additive or subtractive manufacturing process may be used to manufacture the body 304 of the holding element 300. In one example, a casting process may be used to manufacture the holding element 300. Alternatively, the front surface 306, the side surfaces 314, 316, and the mounting legs 324, 326 may be manufactured as separate components and assembled later on to form the holding element 300.

Referring to FIGS. 4, 5 and 6, the bracket assembly 301 includes a mold member 400. The mold member 400 may be made of a non-metallic material having the ability to be compressed. In one example, the mold member 400 may be cast as a separate piece, and later on assembled with the holding element 300. Alternatively, the mold member 400 may include casting and solidification of the mold member 400 around the holding element 300. In one example, the mold member 400 may be made of urethane, but is not limited thereto. The mold member 400 extends from the inner side 318 of the holding element 300. Further, the mold member 400 includes a cavity 402 formed therein. The cavity 402 is configured to receive the holding element 300 therein.

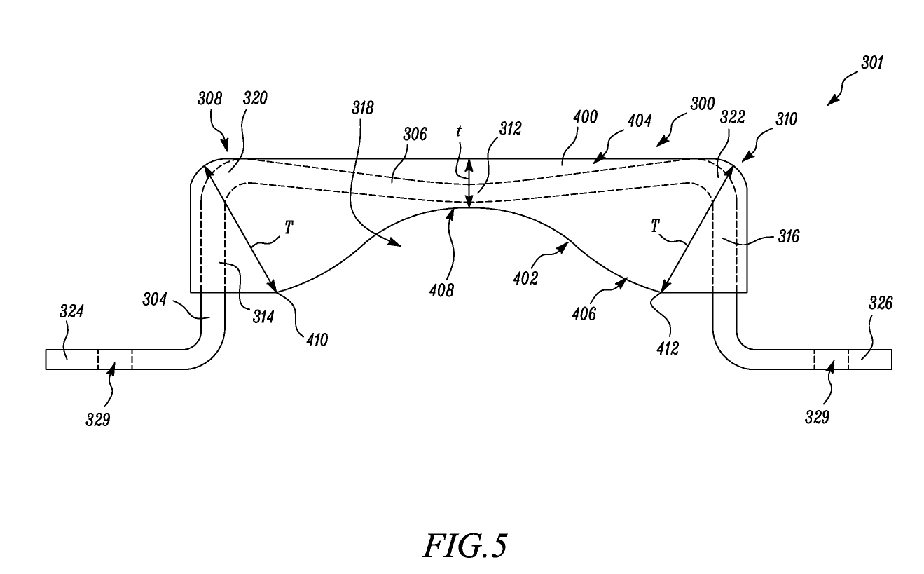

The mold member 400 includes a first surface 404 and a second surface 406. The first surface 404 of the mold member 400 may have a planar profile. Alternatively, the first surface 404 of the mold member 400 may have a curved profile. The second surface 406 of the mold member 400 has a curved profile 408. The curved profile 408 includes a pair of surfaces 410, 412 configured to contact with the accumulator 202. As shown in FIGS. 4 and 5, a thickness “T” of the mold member 400 at the corner portions 320, 322 is greater than a thickness “t” of the mold member 400 near the front surface 306 of the holding element 300. More particularly, the thickness “T” of the mold member 400 from the surface 410, 412 towards the respective corner portion 320, 322 is greater than the thickness “t” of the mold member 400 towards the front surface 306 of the holding element 300. A portion of the mold member 400 near the corner portion 320, 322 of the holding element 300 is configured to be in a contacting relationship with the accumulators 202 and compresses against the accumulator 202 to hold it in place (see FIG. 2). An increased thickness “T” of the mold member 400 near the corner portion 320, 322 allows for optimal compression of the mold member 400 and provides a sturdy holding of the accumulators 202 within the holder assembly 200.

It should be noted that the design of the mold member 400 is not limited to that explained herein, and may vary based on system requirements. For example, in one embodiment, instead of two contacting surfaces 410, 412, a single surface of the mold member 400 may contact the accumulator 202. In such an example, a thickness of the mold member 400 at the single surface may be greater as compared to a thickness near remaining portions of the mold member 400.

As shown in FIG. 6, the accumulators 202 are held within an interior space 414 formed between the holding element 300 and the cut portion 216 of the housing 212. Further, when provided within the interior space 414, the accumulators 202 are configured to contact the surfaces 410, 412 of the mold member 400 and also rest against the pad 226. Although the present disclosure is explained in context with the holder assembly 200 for the accumulators 202 of the steering system of the machine 100. It should be appreciated that the scope of the present disclosure is not limited thereto, and may be extended to the holding of any accumulator that are associated with the machine 100.

### INDUSTRIAL APPLICABILITY

Hydraulic systems associated with a steering system of a machine generally include a plurality of accumulators. The accumulators are configured to store pressurized fluid source therein. A size of the accumulator varies based on a type of the machine and an operating environment of the machine. Accumulators for the machine, such as a mining truck are generally heavy in weight. The mounting of these accumulators onto a frame of the machine requires a robust holder assembly, to ensure the accumulators remain functional and undamaged.

The present disclosure describes the holder assembly 200 for the accumulators 202. The holder assembly 200 includes the housing 212. The housing 212 includes the plurality of cut portions 216. In one example, the cut portions 216 may be provided using the laser cutting operation. The holder assembly 200 further includes the bracket assembly 301. The bracket assembly 301 is coupled to the housing 212 using the mechanical fasteners 328. The bracket assembly 301 includes the holding element 300, 302 and the mold member 400. The body 304 of the holding element 300, 302 may be completely or partially received within the mold member 400.

The mold member 400 of the bracket assembly 301 may be made of urethane, allowing for optimal compression. Further, the mold member 400 has the thickness “T” which is thicker near the corner portions 320, 322 of the holding element 300, 302 in order to firmly hold the accumulator 202 within the interior space 414. The accumulators 202 are supported within the holder assembly 200, such that the accumulators 202 are supported at three points, i.e., by the surfaces 410, 412 and by the pad 226 respectively. Alternatively, the accumulators 202 may be supported within the holder assembly 200 at two points, i.e., by a single surface of the mold member 400 and by the pad 226 respectively. This feature ensures and promotes a stable holding of the accumulators 202 within the holder assembly 200. The present design of the holder assembly 200 can accommodate an array of tolerances and provide a solid bolted joint. The holder assembly 200 has a robust and sturdy structure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A bracket assembly for an accumulator, the bracket assembly comprising:
a holding element comprising:
a body having a front surface and two side surfaces, the two side surfaces extending from the two ends of the front surface, wherein an inner side of the holding element is configured to face the accumulator; and
a corner portion disposed at each of the two ends of the front surface, the corner portion formed by an angular relationship between the front surface and each of the two side surfaces at the respective end of the front surface; and
a mold member extending from the inner side of the holding element, wherein a thickness of the mold member at the corner portion is greater than a thickness of the mold member at the front surface of the holding element, such that the mold member at the corner portion is configured to be in a contacting relationship with the accumulator.

2. The bracket assembly of claim 1, wherein the angular relationship between the front surface and each of the two side surfaces at the respective end of the front surface is between 65 to 100 degrees.

3. The bracket assembly of claim 1, wherein the front surface of the holding element has a bent shape at a central portion of the front surface.

4. The bracket assembly of claim 1 further comprising a pair of mounting legs extending from the two side surfaces, the pair of mounting legs configured to couple to a surface.

5. The bracket assembly of claim 1, wherein the mold member is made of urethane.

6. The bracket assembly of claim 1, wherein the mold member includes a cavity formed therein such that the holding element is configured to be received into the cavity.

7. The bracket assembly of claim 1, wherein a surface of the mold member has a curved profile with a surface configured to contact with the accumulator.

8. A holder assembly for an accumulator, the holder assembly comprising:
a housing having a hollow configuration, the housing including one or more cut portions formed thereon, the one or more cut portions provided laterally spaced apart from each other, wherein each of the one or more cut portions has a curved profile configured to receive the accumulator therein;
a holding element coupled to the housing, the holding element comprising:
a body having a front surface and two side surfaces, the two side surfaces extending from the two ends of the front surface, wherein an inner side of the holding element is configured to face the accumulator; and
a corner portion disposed at each of the two ends of the front surface, the corner portion formed by an angular relationship between the front surface and each of the two side surfaces at the respective end of the front surface; and
a mold member extending from the inner side of the holding element, wherein a thickness of the mold member at the corner portion is greater than a thickness of the mold member at the front surface of the holding element, such that the mold member at the corner portion is configured to be in a contacting relationship with the accumulator.

9. The holder assembly of claim 8, wherein the housing is a unitary unit.

10. The holder assembly of claim 8, wherein the housing includes attachment surfaces provided between adjacent cut portions, wherein the attachment surfaces are configured to be coupled to the holding element.

11. The holder assembly of claim 10 further comprising a pair of mounting legs extending from the two side surfaces, the pair of mounting legs configured to couple to the attachment surfaces.

12. The holder assembly of claim 8, wherein the one or more cut portions are formed using laser cutting.

13. The holder assembly of claim 8, wherein the angular relationship between the front surface and each of the two side surfaces at the respective end of the front surface is between 65 to 100 degrees.

14. The holder assembly of claim 8, wherein the front surface of the holding element has a bent shape at a central portion of the front surface.

15. The holder assembly of claim 8, wherein the mold member is made of urethane.

16. The holder assembly of claim 8, wherein the mold member includes a cavity formed therein such that the holding element is configured to be received into the cavity.

17. The holder assembly of claim 8, wherein a first surface of the mold member has a planar profile configured to contact with the holding element and a second surface of the mold member has a curved profile with a surface configured to contact with the accumulator.

18. A system comprising:
a plurality of accumulators; and
a holder assembly for each of the plurality of accumulators, the holder assembly comprising:
a housing having a hollow configuration, the housing including one or more cut portions formed thereon, the one or more cut portions provided laterally spaced apart from each other, wherein each of the one or more cut portions has a curved profile to receive each of the plurality of accumulators therein;
a holding element coupled to the housing, the holding element comprising:
a body having a front surface and two side surfaces, the two side surfaces extending from the two ends of the front surface, wherein an inner side of the holding element faces each of the plurality of accumulators; and
a corner portion disposed at each of the two ends of the front surface, the corner portion formed by an angular relationship between the front surface and each of the two side surfaces at the respective end of the front surface; and
a mold member extending from the inner side of the holding element, wherein a thickness of the mold member at the corner portion is greater than a thickness of the mold member at the front surface of the holding element, such that the mold member at the corner portion is in a contacting relationship with each of the plurality of accumulators.

19. The system of claim 18 further comprising a fixture plate provided at a bottom portion of the plurality of accumulators.

20. The system of claim 18, wherein a first holder assembly is coupled to a top portion of each of the plurality of accumulators and a second holder assembly is coupled to a bottom portion of each of the plurality of accumulators.
